(19) United States
(12) Patent Application Publication
(10) Pub. No.: US 2008/0135412 A1
(43) Pub. Date: Jun. 12, 2008

(54) Adaptable Ultrasound Positioning System For an Electronic Brush

(75) Inventors: Hubertus M.R. Cortenraad, Eindhoven (NL); Anthonie H. Bergman, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/562,283

(22) PCT Filed: Jun. 23, 2004
(86) PCT No.: PCT/IB04/50987

§ 371 Date: Dec. 22, 2005

Related U.S. Application Data
(60) Provisional application No. 60/482,949, filed on Jun. 27, 2003.

(51) Int. Cl. G02F 1/167; G06F 3/033; G09F 9/37

(52) U.S. Cl. 204/554; 204/663

(57) ABSTRACT

The invention provides a system for activating an electronic paint including at least two independently movable ultrasonic transducers (20,22), an electronic brush (30) including an electronic-brush ultrasonic transducer (32), and a controller (40). The controller (40) is operably coupled to the two independently movable ultrasonic transducers (20,22) and the electronic-brush ultrasonic transducer (32). An electronic-brush location with respect to locations of the independently movable ultrasonic transducers (20,22) is determined from ultrasonic signals communicated between the ultrasonic transducers (20,22) and received by the controller (40).

This invention relates generally to electronic paint activation, and more particularly, to an electronic brush with an ultrasonic positioning system and methods for determining electronic-brush location and rotation.

Electronic displays for applications such as whiteboards, signs, and billboards have been the subject of recent research and development. In many cases these displays are infrequently updated, with days or even weeks or months between updates. Emergent electronic-ink technologies based on electrophoresis can produce paper-like displays, suitable for these kinds of large displays. Most electronic-ink systems for large electrophoretic displays have no intrinsic addressing schemes, such as fixed coordinates on a pixel-by-pixel grid.

Electrophoretic displays can be bistable, in that their display elements have first and second display states that differ in at least one optical property such as lightness or darkness of a color. In recent electrophoretic displays, the display states occur after microencapsulated particles in the electronic ink have been driven to one state or another by means of an electronic pulse of a finite duration, and the driven state persists after the voltage has been removed. Such displays can have attributes of good brightness and contrast, wide-viewing angles, state bi-stability, and low power consumption when compared with liquid crystal displays (LCDs).

One proposed technology for these applications uses a thin electrophoretic film with millions of tiny microcapsules in which positively charged white particles and negatively charged black particles are suspended in a clear fluid. When a negative electric field is applied to the display, the white particles move to the top of the microcapsule where they become visible to the user. This makes the surface appear white at that top position of the microcapsule. At the same time, the electric field pulls the black particles to the bottom of the microcapsules where they are hidden. When the process is reversed, the black particles appear at the top of the microcapsule, which makes the surface appear dark at the top position of the microcapsule. When the voltage is removed, a fixed image remains on the display surface. Before another image is written, the so-called electronic ink of the display material may need to be set to a well-defined state, such as an all white surface with white particles moved to the top of the microcapsules, prior to re-addressing the ink. This can be accomplished by, for example, irradiating the entire display or applying a relatively high voltage to the terminals and electrodes of the display, forcing the ink into one state through the applied electric field.

Currently these encapsulated, electrophoretic displays are being developed and designed for applications such as personal digital assistants (PDAs), mobile phones, electronic-mail devices, and electronic readers. Research continues to focus on creating a thin digital or electronic-ink display that looks and feels like a piece of paper. Electronic-ink displays are attractive because they can be more than six times brighter than reflective liquid-crystal displays (LCDs) and can be seen at any angle without a change in contrast, unlike LCDs. Gates and others describe addressing schemes for controlling such bistable electronically addressable displays in “Methods for Addressing Electrophoretic Displays”, Gates, U.S. Pat. No. 6,531,997 issued Mar. 11, 2003.

Digital- or electronic-ink technology has the potential to be extended to a large electronic wall display of a so-called electronic wallpaper, poster or wall screen, which could comprise a thin electrophoretic film placed on a wall. The display would be appropriate where semi-permanent images are required such as electronic wallpaper/advertisement medium. This electronic low-cost paint application also could be used, for example, for putting a shopping list, the latest vacation pictures, or family pictures on a home wall. It also could be a standby alternative for other displays such as a polymer-based organic light emitting diode display that consume significant power while operating or in a stand-by mode.

Unfortunately, present-day electrophoretic displays are difficult to address using passive matrix driving, and thus, an active matrix has been required for a matrix-type display. This is not an attractive option for inexpensive billboard-like displays, which require only a low to extremely low refresh rate.

Methods and related input devices have been developed to electrically address and control smaller electrophoretic displays, particularly those the size of writing paper or smaller. In the case of handheld personal computers, PDAs or web-enabled mobile phones, an electronic input device usually generates data by a user writing and drawing on a touch-sensitive screen of the device, or on a writing tablet with a stylus or other pointing device. Current digital-ink technology can extract information from the handwriting, including the contact pressure, vector, timing, coordinates, and angle of the stylus on the writing surface. One method that provides additional line thickness information is described in “Method of Generating Digital Ink Thickness Information”, U.S. Patent Application, 2002/0163510, Williams et al., Nov. 7, 2002. The method and associated system

convert the ballistic movement of a point of a pen over a writing surface into thickness information for digital ink data. The pen includes at least one accelerometer that is used to generate either ballistic movement or ballistic pen tilting information.

Addressing an electrophoretic display with a non-conductive brush that is moistened with a conductive liquid is described in “Methods for Addressing Electro-Optic Materials”, Goenaga et al., U.S. Patent Application 2003/0053189 published Mar. 20, 2003. The method detects a potential difference between the moistened, non-conductive brush and the display. The electrically charged fluid from the pen carries an electronic charge onto the electro-optic material of the display, thereby causing dark particles in the electrophoretic fluid of microscapsules to the top of the microcapsules, which appear as a dark electronic ink contrasted against the light background of the display fluid or light-colored particles.

Relative positioning systems have been created to detect the motion of a pen on a writing surface, as described in “Electronic Module for Sensing Pen Motion”, U.S. Patent Application 2002/0181744, Vablais et al., Dec. 5, 2002. An electronic module is preferably mounted in a substitute ink cartridge and includes an accelerometer for detecting pen motion. Ballistic information generated by the accelerometer is transmitted via the radio transmitter to a computer where it can be processed for handwriting recognition or digital-ink generation.

A handwriting system with a position detection system that can electronically capture handwriting or drawings from a standard piece of paper is commercially available. The system comprises a battery-powered motion-sensing device that clips to a pad of paper, a wireless electronic pen device, and infrared (IrDA) transceiver. The clip device monitors and senses the location of the electronic pen and transfers data by wire to an the IrDA transceiver, which in turn sends data on to an IrDA-enabled handheld, laptop, or desktop personal computer.

More of the research in the area of larger electrophoretic display systems has focused on transmitting data from an electrophoretic surface on a wall to a computer, rather than transmitting data to the electrophoretic surface. A larger display system has been designed to electronically capture drawings and text written on a standard whiteboard and convert them to computer data; A portable Internet device, which attaches to a standard whiteboard, employs infrared and ultrasound technology to track the position of marker stylus and eraser on the board. An electrophoretic display has been employed in an erasable drawing device such as a blackboard, paper pad, or whiteboard, as disclosed in “Microencapsulated Electrophoretic Electrostatically-Addressed Media for Drawing Device Applications”, Comiskey et al., U.S. Pat. No. 6,473,072 issued Oct. 29, 2002. The display

includes an encapsulated electrophoretic display media, a rear electrode, and a movable electrode. The encapsulated display media comprises a plurality of capsules, each capsule comprising a plurality of particles dispersed in a fluid. An electric field is applied across the display media with the rear electrode adjacent the rear surface of the display media and across the movable electrode, which can be in the form of a marker or an eraser and is positioned adjacent the frontward surface.

A process for creating electronically addressable displays with electronic ink is described in “Transducer and Indicators having Printed Displays”, Albert et al., International Patent WO9910769 and U.S. Pat. No. 6,118,426, both granted Sep. 12, 2000. Suggested applications include small sticker displays for consumer goods like fruit, milk, or batteries, which could be used as freshness indicators by changing the state of the displays after a certain time has elapsed. Other applications include those where it is useful to provide intermittent updates, or when a certain pressure, thermal, radiative, moisture, acoustic, inclination, pH, or other threshold is passed at the position of the display. The display system may use radio frequencies to power, address and control the display, and include one or more antennae, passive charging circuitry, and active control system, a display, and an energy storage unit. A separate transmitter provides remote power for the display. A tile-based display allowing a modular system for large printable area has been suggested with traces disposed on a substrate.

The technological advancements in electrophoretic materials have led to the development of larger and more complex displays. For example, individual display elements can be tiled to create a complex, selectively illuminated, three-dimensional display structures, as described in “Illumination System for Nonemissive Electronic Displays”, Comiskey, WO0020923 published Apr. 13, 2000. The display may be updated using electromagnetic radiation.

The technology used to address smaller electrophoretic displays can be applied to larger display systems such as tiled arrays of displays, but there are alignment and addressing issues for transferring data such as images or text to a large and variably sized display material, such as on a wall, that avoid gaps and dead-band regions while retaining constant magnification across adjacent tiles. In other types of wall-display technologies such as light-projection systems, methods of processing, sectionalizing and transferring a large display of data onto a wall have been developed. A large projected display has been created with multiple display devices, a screen, and multiple lens assemblies, as described in “Seamless Tiled Display System”, Dubin et al., U.S. Patent Application 2002/0080302 published Jun. 27, 2002. A scalable seamless tiled display is subdivided into multiple

sections, and each section is configured to display a sectional image. One of the lens assemblies is optically coupled to each of the sections of each of the display devices to project the sectional image displayed on that section onto the screen.

One issue for successful addressing of electrophoretic material, particularly on a larger area such as a wall, is how to control the ambient and other outside light that may cause incorrect addressing during the application of a voltage and the addressing light. The outside photoconductive layer of the display material usually does not fully block the voltage needed for addressing, and depending on the capacitance values of the photoconductor and the electronic ink underneath, a voltage over the ink may remain and inadvertently address or erase the e-ink. There needs to be a successful combination of the resistivity of the matrix with the photoelectric properties of the photoconductive layer so that the display can be insensitive to the dimmer surrounding light, while it is addressable by the brighter addressing light.

In order for the electronic paint or electronic ink to be feasible for use in large, inexpensive wall displays, a handheld device for addressing the electrophoretic material is needed. Any type of brush, stylus, or addressing device for electronic ink needs to be able to write to or activate the electronic paint. In one approach, a voltage is applied across the surface of an electrophoretic display, and a handheld laser scanner locally changes the conductivity of a photoconductor, thereby causing the encapsulated electrophoretic material to change state as desired. The addressing device should have or be connected to some type of computer memory that stores the image or text being conveyed to the display. The device should be equipped to identify or sense the position and tilt of the device, and to detect the location of the device in relation to the display surface.

Transferring data such as a large picture or image to passive electrophoretic material on a wall poses problems with aligning strokes of the handheld device when multiple strokes over the wall are needed. For example, a one meter by one meter display may require at least five different strokes of a handheld device that has a 20-centimeter long addressing mechanism, in much the same way that any wall being painted requires multiple strokes with a paint roller. Painting with electronic paint requires a process whereby the position of the input device can be determined accurately and multiple strokes over the surface of the electronic paint do not cause alignment artifacts of the device.

Other technologies have developed systems to sense or track handheld devices. For example, handheld three-dimensional laser scanners can measure three-dimensional surfaces as they move or sweep smoothly near an object and send data to a computer. A computer application converts measurement data into computer generated images, with the finished scan combining overlapping sweeps to develop surface models of non-metal objects.

Other tracking systems use one or more receivers simultaneously to measure and capture the movement of any given subject or object in real time. Tracking systems have been used to track digital pen devices that digitally capture handwritten material written on digital paper. In this particular application, the tracked writing device comprises a digital camera or optical sensor, an image-processing unit that digitizes handwritten words and images, and a communication unit that transfers digitized data through a USB cradle to a computer. Other handheld devices may use small dual-axis gyroscopes, which have already been integrated into a variety of digital and analog application circuits in devices such as computer mice or remote controls and are being developed for applications such as computer-pointer, robotic, factory-automation, antenna-stabilization and auto-navigation devices.

Cartesian, polar or other coordinates provided by a scanning device have been used to represent the location of images or text data on a display. For example, a method using SONAR positioning to obtain coordinates for the display of data on a screen is disclosed in “Method of Displaying Digital Data Provided in Polar Coordinates by a Panoramic Scanning Device, such as a Radar, Sonar Apparatus or the Like, on a Screen Frame with Cartesian Coordinates”, Ziese, Patent EP0118125 issued Sep. 12, 1984. An angular coordinate increment is determined and used to help maintain the resolution of a panoramic picture.

In light of the discussion above, there is still a need for an effective and relatively inexpensive electronic output device to control and transfer data to the passive-matrix surface of a large electrophoretic wall display without alignment and problems associated with multiple strokes of the device and rotations of the device. Therefore, it is the intent of this invention to provide an electronic input device, along with an associated system and method, to control and transfer digital data to a large electrophoretic wall display, electronically painting a picture without alignment artifacts of the device, thereby overcoming the challenges and obstacles described above.

One aspect of the invention is a system for activating an electronic paint. The system includes at least two independently movable ultrasonic transducers, an electronic brush that includes at least one electronic-brush ultrasonic transducer, and a controller. The controller is operably coupled to the two independently movable ultrasonic transducers and the electronic-brush ultrasonic transducers. An electronic-brush location with respect to locations of the independently movable ultrasonic transducers is determined from ultrasonic signals communicated between the ultrasonic transducers and received by the controller.

Another aspect of the invention is a method of activating an electronic paint. The method includes the steps of positioning a first ultrasonic transducer on a surface containing the electronic paint. A second ultrasonic transducer spaced apart from the first ultrasonic transducer is positioned on the surface. A first ultrasonic signal is sent between the first ultrasonic transducer and an electronic-brush ultrasonic transducer attached to an electronic brush. A second ultrasonic signal is sent between the second ultrasonic transducer and the electronic-brush ultrasonic transducer. A location of the electronic brush is determined with respect to the first and second ultrasonic transducers based on the first and the second ultrasonic signals.

Another aspect of the invention is a system for activating an electronic paint. The electronic activation system includes means for sending ultrasonic signals between a plurality of spaced-apart electronic-paint surface locations and an electronic brush; and means for determining an electronic-brush location with respect to electronic-brush surface locations based on the ultrasonic signals.

Another aspect of the invention is an electronic brush, including a housing and at least one ultrasonic transducer attached to the housing. Ultrasonic signals communicated between the electronic-brush ultrasonic transducer and at least two ultrasonic transducers positioned on a surface allow a determination to be made of an electronic-brush location, with respect to locations of the ultrasonic transducers positioned on the surface.

The aforementioned and other features and advantages of the invention will become further apparent from the following detailed description of the presently preferred embodiments, read in conjunction with the accompanying drawings. The detailed description and drawings are merely illustrative of the invention rather than limiting, the scope of the invention being defined by the appended claims and equivalents thereof.

Various embodiment of the present invention are illustrated by the accompanying figures, wherein:

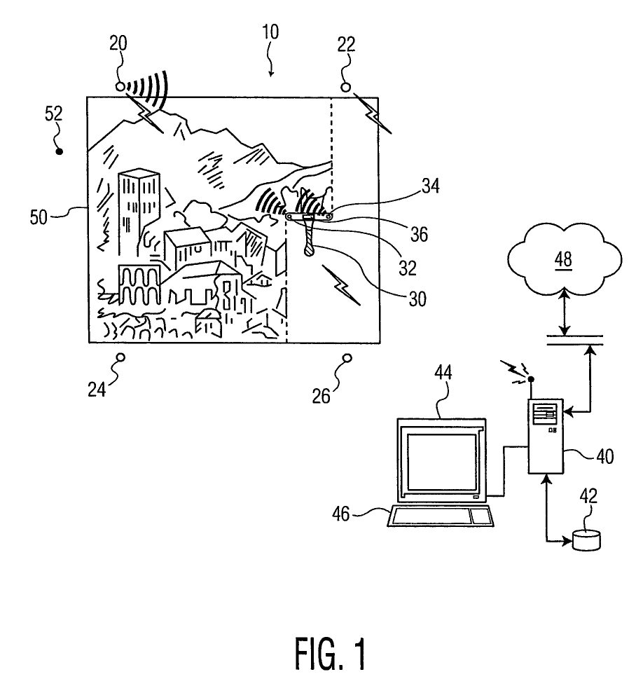

FIG. 1 is an illustration of a system for activating an electronic paint, in accordance with one embodiment of the current invention;

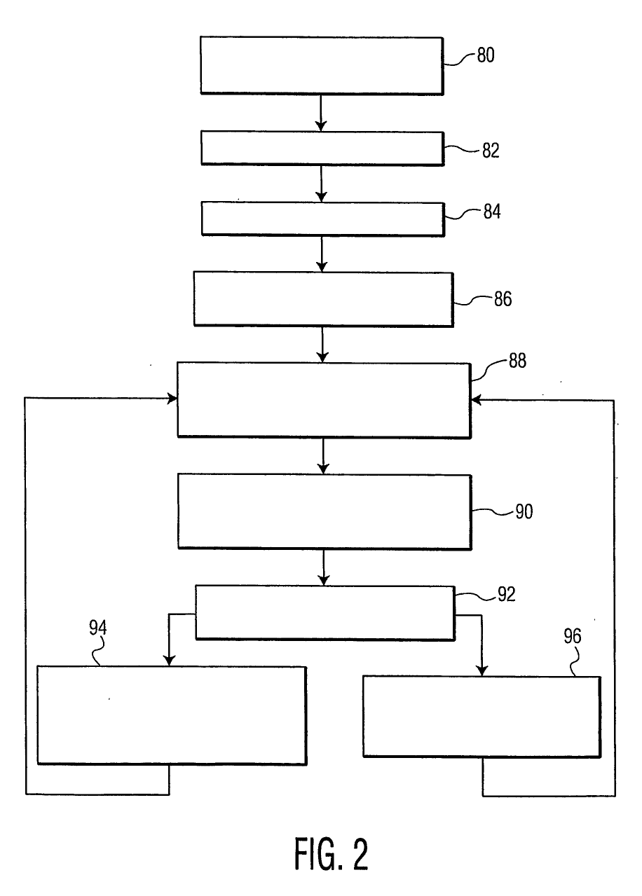

FIG. 2 is flow diagram of a method for activating an electronic paint, in accordance with one embodiment of the current invention;

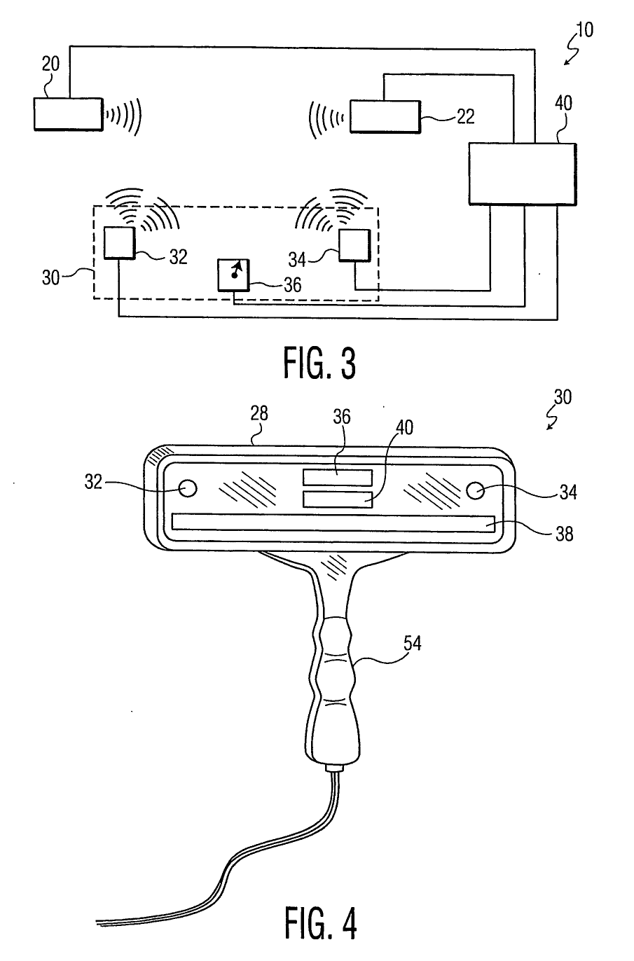

FIG. 3 is a block diagram of a system for activating an electronic paint, in accordance with one embodiment of the current invention; and

FIG. 4 is an illustration of an electronic brush, in accordance with one embodiment of the current invention.

FIG. 1 shows an illustration of a system for activating an electronic paint, in accordance with one embodiment of the present invention. Electronic-paint activation system 10 includes at least two independently movable ultrasonic transducers 20 and 22, which are placed at spaced-apart surface location on a surface 52. Electronic brush 30 includes and electronic-brush ultrasonic transducer 32, and a controller 40 operably coupled to ultrasonic transducers 20 and 22. Based on ultrasonic signals communicated between ultrasonic transducers 20, 22 and 32, the location of the electronic brush with respect to locations of independently movable ultrasonic transducers 20 and 22 is determined. Controller 40 receives signals that are communicated between ultrasonic transducers 20, 22 and 32, which may be connected by wire or wirelessly to controller 40. Similarly, electronic-brush ultrasonic transducer 32 may be wired or wirelessly connected to controller 40. Controller 40 is located, for example, in electronic brush 30 or in a digital computing device operably coupled to electronic brush 30. A wireless communication protocol such as 802.11a, 802.11b or 802.11g may be used to interconnect ultrasonic transducers 20 and 22 to controller 40. Similarly, electronic brush 30 may be wirelessly connected to an external controller 40.

Ultrasonic transducers 20 and 22 transmit and receive ultrasonic signals or ultrasound wave packages to determine a distance between them. Using a triangulation scheme, the distance between ultrasonic transducers 20 and 22 and electronic-brush ultrasonic transducer 32 attached to electronic brush 30 can be ascertained, and therefrom determine the location of electronic brush 30 with respect to the locations of ultrasonic transducers 20 and 22. Ultrasonic transducers 20 and 22 are attachable to surface 52 containing an electronic paint 50, such as with suction cups, mounting brackets, hanging hardware or other suitable attachment hardware. Ultrasonic transducers 20 and 22 and electronic paint 50 are attachable to surface 52, readily adapted to accommodate various sizes of electronic paint and image dimensions. Ultrasonic transducers 20 and 22 may be placed and affixed to a baseboard, molding, skirting or other suitable portion of surface 52. Alternatively, ultrasonic transducers 20 and 22 may be attached directly to a panel or board comprising electronic paint 50. Although a less flexible configuration than independently spaced ultrasonic transducers 20 and 22, ultrasonic transducers 20 and 22 may be coupled at a known separation distance to a structure such as a bar that is attachable to the wall or surface. Commercially available ultrasonic transducers 20, 22 and 32 are capable of sending or receiving ultrasonic signals, comprising piezoelectric elements that generate high-frequency sound waves from electronic signals applied to the elements and that produce electrical voltages when impinged by sound waves. Time-of-flight measurements of sound waves launched from one ultrasonic transducer to another provide an indication of the distance between ultrasonic transducers 20, 22 and 32.

Ultrasonic transducers 20 and 22 are attached, for example, near an upper edge of electronic paint 50, separated from each other with one near an upper left corner and another near an upper right corner. Additional ultrasonic transducers such as ultrasonic transducers 24 and 26 may be attached to surface 52, further defining the boundaries of electronic paint 50 and the periphery of any picture or image to be transferred thereon. Though depicted on a wall and serving as an electronic wallpaper, surface 52 comprising electronic paint 50 may alternatively be on a desk, table, floor, ceiling, billboard, whiteboard, or other suitable surface. Electronic paint 50 comprises, for example, an electrophoretic display or optically addressed electronic ink.

An exemplary electronic brush 30, which has a relatively flat, elongated surface area in the shape of a strip or bar, passes over portions of surface 52 to address and activate electronic paint 50. As electronic brush 30 is moved or swept across electronic paint 50, an image including text, drawings, pictures, or combinations thereof, is transferred or written onto electronic paint 50. Electronic paint 50 is addressed by determining an electronic-brush location and writing the intended image accordingly. The image may be frozen, for example, by removing an activation voltage from across the electronic paint or ink.

When small rotations of electronic brush 30 occur during brush sweeps across electronic paint 50, the result could be excessive waviness and aberrations of the intended image being transferred onto surface 52. Compensation of electronic-brush rotations may be made using, for example, with a second ultrasonic transducer 34 attached to electronic brush 30. A determination of electronic-brush rotation can be made as electronic brush 30 is passed over electronic paint 50, and used to compensate for electronic-brush rotations while the intended image is being written. Electronic-brush ultrasonic transducer 34 is spaced apart from electronic-brush ultrasonic transducer 32, so that an electronic-brush rotation can be determined from ultrasonic signals communicated between electronic-brush ultrasonic transducer 32, electronic-brush ultrasonic transducer 34, and one or more of the independently movable ultrasonic transducers 20, 22, 24 and 26.

Electronic-brush rotation can alternatively be determined with a tilt sensor 36 attached to electronic brush 30. Tilt sensor 36 comprising, for example, a commercially available inclinometer, accelerometer, or bubble detection device, can determine an upward direction with respect to gravitational forces, and then data written onto electronic paint 50 while electronic brush 30 is swept over surface 52 is compensated accordingly. Tilt signals from tilt sensor 36 may be received at controller 40 to determine an electronic-brush rotation.

Data, pixel and address information to be written onto electronic paint 50 may be transferred to and stored within electronic brush 30, written onto electronic paint 50 under control of on-board controller 40. Alternatively, a controller 40 such as a personal computer, a laptop computer, a personal digital assistance, a modified cell phone, a wireless device or a digital computing device can be used to store pixel and address information related to electronic paint 50. Controller 40 may be wired or wirelessly connected to electronic brush 30. Controller 40 may contain a database or a memory 42 such as a memory stick with the intended image. Selection and manipulations of the intended image prior to writing onto electronic paint 50 may be made, for example, with the help of computer software and hardware such as display 44 and the input devices 46 like a keyboard or a mouse. Controller 40 may have an Internet or web connection 48 to generate, select or receive image information.

FIG. 2 shows a flow diagram of a method for activating an electronic paint, in accordance with one embodiment of the present invention. The electronic-paint activation method includes steps to activate an electronic paint on a surface such as a wall by using an electronic brush.

Two or more ultrasonic transducers are positioned 80 on a surface. A first ultrasonic transducer is positioned on a surface containing the electronic paint, and a second ultrasonic transducer is positioned on the same electronic-paint surface, spaced apart from the first ultrasonic transducer. The size and position of the intended image is determined in part by the placement of the ultrasonic transducers. Using suction cups, mounting holes or other suitable mounting hardware, the ultrasonic transducers are positioned on the surface such as along an upper edge of the electronic paint surface. Connected wirelessly or by wire to an on-brush or external controller, the ultrasonic transducers can generate and receive ultrasonic signals so that distances between them and other ultrasonic transducers attached to an electronic brush can be determined.

An ultrasonic signal is emitted 82 from one of the ultrasonic transducers positioned on the surface and functioning as a transmitter. At a prescribed time and frequency, the ultrasonic signal is emitted in accordance with an electronic signal applied to the ultrasonic transducer in correspondence with the controller. Once launched, the emitted sound wave traverses through the air or through the electronic paint surface to be detected by another ultrasonic transducer positioned on the surface.

The ultrasonic signal is received 84 at a second ultrasonic transducer positioned on the surface and acting as a receiver. The received ultrasonic signal generates an output voltage based on the frequency of the sound wave, the time of launch, the distance between the transducers, and the speed of sound through relevant media. The output voltage is sent to the controller for analysis.

The distance between the two ultrasonic transducers is determined 86. The distance between a first ultrasonic-transducer location and a second ultrasonic-transducer location is determined based on the emitted ultrasonic signal and the received ultrasonic signal. From time-of-flight measurements of the wave packages, the distances between the one or more ultrasonic transducers mounted or attached to the surface are computed. Distance measurements are determined, for example, by dividing the time between the launch of an ultrasonic signal with a first ultrasonic transducer and the reception of the ultrasonic signal with a second ultrasonic transducer by the speed of sound through the air or through the surface of the electronic paint. Distances between the two ultrasonic transducers range, for example, between ten centimeters and two meters or more. After the ultrasonic transducers locations are calibrated and the distance between the first and second ultrasonic transducers is determined, triangulation methods can be used to determine the location of ultrasonic transducers attached to an electronic brush.

A first ultrasonic signal is sent 88 between a first ultrasonic transducer and an ultrasonic transducer attached to or mounted on the electronic brush. The ultrasonic signal may be launched from either the independently movable ultrasonic transducer or the electronic-brush ultrasonic transducer, since the time-of flight between the ultrasonic transducers is the same in either direction and ultrasonic transducers are often used as either a transmitter or a receiver.

To determine the electronic-brush location from triangulation, a second ultrasonic signal is sent 90 between a second ultrasonic transducer positioned on the electronic paint surface and the electronic-brush ultrasonic transducer. Using the measured time of flight, the distance between the second ultrasonic transducer and the electronic-brush ultrasonic transducer can be determined. The second wave package may be sent, for example, sequentially in time with the first wave package or at a different frequency. Alternately, the electronic-brush ultrasonic transducer acting as a transmitter may send the first ultrasonic signal and the second ultrasonic signal simultaneously to the surface-mounted ultrasonic transducers for reception and electronic-brush location determination.

The location of the electronic brush is then determined 92. The electronic-brush location with respect to the first and second ultrasonic transducers is determined based on the first ultrasonic signal and second ultrasonic signal. Using a triangulation computation, the location of the electronic brush can be determined. For example, if the distance between the independently movable ultrasonic transducers is forty centimeters, and the distances between the independently movable ultrasonic transducers and the electronic-brush ultrasonic transducer are thirty centimeters and fifty centimeters from the first ultrasonic transducer and the second ultrasonic transducer, respectively, then the electronic-brush location is directly below or above the first ultrasonic transducer with a distance of thirty centimeters.

Rotations of the electronic brush with respect to the surface of the electronic paint as the electronic brush is brushed across the electronic-paint surface require compensation for writing smooth, non-distorted images onto the electronic paint. An electronic-brush rotation may be determined 94 based on ultrasonic signals. The electronic-brush rotation may be determined based on ultrasonic signals communicated between the first electronic-brush ultrasonic transducer, a second electronic-brush ultrasonic transducer spaced apart from the first electronic-brush ultrasonic transducer, and at least one of the first or second ultrasonic transducers positioned on the surface. For example, the electronic-brush rotation can be determined by measuring the distances between each electronic-brush transducer and one of the wall-mounted ultrasonic transducers, then calculating the electronic-brush rotation from the measured distances and the electronic-brush location.

The electronic-brush rotation can alternatively be determined 96 with a tilt sensor attached to the electronic brush. The electronic-brush rotation is determined based on tilt signals from an electronic-brush tilt sensor attached to the electronic brush. Signals from the tilt sensor indicate the brush angle with respect to a gravitational vector, and can be processed by the controller to determine the electronic-brush rotation and to compensate the image data accordingly.

As the electronic brush is moved across the electronic paint, the location and angle of the electronic brush is monitored and updated so that image information can be appropriately addressed and written onto the electronic paint. Steps indicated at block 88 and following are repeated until the entire image is written onto the electronic paint. For larger images, the electronic brush may be passed multiple times across the electronic paint to construct a complete picture. Accurate determination of the electronic brush location and rotation reduces alignment artifacts that can be caused by multiple strokes of the brush. After the image has been painted, the ultrasonic transducers may be removed from the wall or surface.

FIG. 3 shows a block diagram of a system for activating an electronic paint, in accordance with one embodiment of the current invention. Electronic-paint activation system 10 includes a plurality of spaced-apart electronic-paint surface locations such as the locations of a first independently movable ultrasonic transducer 20 and a second independently movable ultrasonic transducer 22, and an electronic brush 30 with an attached ultrasonic transducer 32. Ultrasonic signals are sent between the plurality of spaced-apart electronic-paint surface locations and electronic brush 30. A controller 40 mounted internal or external to electronic brush 30 determines an electronic-brush location with respect to the electronic-brush surface locations based on the ultrasonic signals. For example, time-of-flight measurements between ultrasonic transducer 20 and electronic-brush ultrasonic transducer 32 are combined with time-of-flight measurements between ultrasonic transducer 22 and electronic-brush ultrasonic transducer 32 to determine the electronic-brush location with respect to the locations of ultrasonic transducer 20 and ultrasonic transducer 22.

An ultrasonic signal may be sent, for example, between a first ultrasonic transducer 20 positioned on an electronic-paint surface, and an electronic-brush ultrasonic transducer 32 attached to electronic brush 30. A second ultrasonic signal is sent between electronic-brush ultrasonic transducer 32 and a second ultrasonic transducer 22, which is spaced apart from first ultrasonic transducer 20. Controller 40 determines an electronic-brush location with respect to ultrasonic signals sent between ultrasonic transducers positioned on the electronic paint surface.

The distance between a first electronic-paint surface location and a second electronic-paint surface location can be determined from ultrasonic signals emitted from the first electronic-paint surface location and the second electronic-paint surface location. For example, an ultrasonic signal is emitted from ultrasonic transducer 20 positioned on the surface and the ultrasonic signal is received at ultrasonic transducer 22 positioned on the surface. From time-of-flight measurements, controller 40 determines the distance between first ultrasonic transducer 20 and second ultrasonic transducer 22 based on the emitted ultrasonic signal and the received ultrasonic signal.

Rotation of electronic brush 30 can be determined based on ultrasonic signals communicated between a plurality of spaced-apart electronic brush locations and the electronic-paint surface location means. For example, to compensate for tilt or rotation of electronic brush 30, a second electronic-brush ultrasonic transducer 34 spaced apart from first ultrasonic transducer 32 is attached to electronic brush 30. Electronic-brush ultrasonic transducers 32 and 34 communicate with one or more ultrasonic transducers 20 and 22 positioned on the surface, and rotations of electronic brush 30 are determined from the ultrasonic signals. In another example, a tilt sensor 36 attached to electronic brush 30 provides tilt signals from which electronic-brush rotations are determined by controller 40.

FIG. 4 illustrates an electronic brush, in accordance with one embodiment of the present invention. Electronic brush 30 includes an electronic-brush housing 28 and at least one ultrasonic transducer 32 attached to electronic-brush housing 28. An electronic paint activation device 38 activates an electronic paint using, for example, a laser scanner that addresses a photoconductor within the electronic paint and can switch the state of the electronic paint or ink by locally changing the conductivity of the photoconductor. Electronic brush 30 may include a gripping handle 54 for ease in handling and manipulation. In one example, ultrasonic signals communicated between electronic-brush ultrasonic transducer 32 and at least two ultrasonic transducers positioned on a surface comprising the electronic paint allow a determination to be made of an electronic-brush location with respect to locations of the ultrasonic transducers positioned on the surface. A second ultrasonic transducer 34 spaced apart from ultrasonic transducer 32 may be attached to the electronic brush, so that rotations of electronic brush 30 can be determined from ultrasonic signals communicated between electronic-brush ultrasonic transducers 32 and 34 and at least one ultrasonic transducer positioned on the surface with the electronic paint.

In another embodiment, electronic brush 30 includes a tilt sensor 36. Tilt signals from tilt sensor 36 that is attached to electronic brush 30 allow an electronic-brush rotation to be determined.

Electronic brush 30 may include a controller operably coupled to electronic-brush ultrasonic transducers 32 and 34 to determined electronic-brush locations and electronic-brush rotations. Controller 40 may be located in electronic brush 30 or in a digital computing device operably coupled to electronic brush 30, with application software and hardware to determine the location and rotation of electronic brush 30 and to write the corresponding image into the electronic paint. Electronic brush 30 may receive image information through a wired or wireless connection that couples electronic brush 30 with controller 40 when controller 40 is located off the brush. The received image information may be stored, for example, within a memory stick or other suitable storage device of electronic brush 30.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein. Each of the systems utilized may also be utilized in conjunction with further systems. The specification and drawings are accordingly to be regarded in an illustrative manner and are not intended to limit the scope of the appended claims.

In interpreting the appended claims, it should be understood that:
a) the word “comprising” does not exclude the presence of other elements or acts than those listed in a given claim;
b) the word “a” or “an” preceding an element does not exclude the presence of a plurality of such elements;
c) any reference numerals in the claims are for illustration purposes only and do not limit their protective scope;
d) several “means” may be represented by the same item or hardware or software implemented structure or function; and
e) each of the disclosed elements may be comprised of hardware portions (e.g., discrete electronic circuitry), software portions (e.g., computer programming), or any combination thereof.

1. A system for activating an electronic paint, comprising:
at least two independently movable ultrasonic transducers (20, 22);
an electronic brush (30) including an electronic-brush ultrasonic transducer (32); and
a controller (40) operably coupled to the two independently movable ultrasonic transducers (20, 22) and the electronic-brush ultrasonic transducer (32), wherein an electronic-brush location with respect to locations of the independently movable ultrasonic transducers (20, 22) is determined from ultrasonic signals communicated between the ultrasonic transducers (20, 22, 32) and received by the controller (40).

2. The system of claim 1 wherein the independently movable ultrasonic transducers (20, 22) are attachable to a surface (52) comprising the electronic paint (50).

3. The system of claim 1 wherein the independently movable ultrasonic transducers (20, 22) are wired or wirelessly connected to the controller (40).

4. The system of claim 1 wherein the electronic-brush ultrasonic transducer (32) is wired or wirelessly connected to the controller (40).

5. The system of claim 1 wherein the controller (40) is located in one of the electronic brush (30) or a digital computing device operably coupled to the electronic brush (30).

6. The system of claim 1 further comprising:
a second ultrasonic transducer (34) attached to the electronic brush (30) and spaced apart from the first electronic-brush ultrasonic transducer (32), wherein ultrasonic signals communicated between the first and second electronic-brush ultrasonic transducers (32, 34) and at least one independently movable ultrasonic transducer (20, 22) allow a determination of an electronic-brush rotation.

7. The system of claim 1 further comprising:
a tilt sensor (36) attached to the electronic brush (30), wherein a tilt signal from the tilt sensor (36) is received at the controller (40) to determine an electronic-brush rotation.

8. A method of activating an electronic paint, comprising:
positioning a first ultrasonic transducer (20) on a surface (52) containing the electronic paint (50);
positioning a second ultrasonic transducer (22) on the surface (52) and spaced apart from the first ultrasonic transducer (20);
sending a first ultrasonic signal between the first ultrasonic transducer (20) and an electronic-brush ultrasonic transducer (32) attached to an electronic brush (30);
sending a second ultrasonic signal between the second ultrasonic transducer (22) and the electronic-brush ultrasonic transducer (32); and
determining an electronic-brush location with respect to the first and second ultrasonic transducers (20, 22) based on the first and the second ultrasonic signals.

9. The method of claim 8 further comprising:
emitting an ultrasonic signal from the first ultrasonic transducer (20) positioned on the surface (52);
receiving the emitted ultrasonic signal at the second ultrasonic transducer (22) positioned on the surface (52); and
determining the distance between a first ultrasonic-transducer location and a second ultrasonic-transducer location based on the emitted ultrasonic signal and the received ultrasonic signal.

10. The method of claim 8 further comprising:
determining an electronic-brush rotation based on ultrasonic signals communicated between the electronic-brush ultrasonic transducer (32), a second electronic-brush ultrasonic transducer (34) spaced apart from the first electronic-brush ultrasonic transducer (32), and at least one of the first and second ultrasonic transducers (20, 22) positioned on the surface (52).

11. The method of claim 8 further comprising:
determining an electronic-brush rotation based on tilt signals from an electronic-brush tilt sensor (36) attached to the electronic brush (30).

12. A system for activating an electronic paint, comprising:
means for sending ultrasonic signals between a plurality of spaced-apart electronic-paint surface locations and an electronic brush (30); and
means for determining an electronic-brush location with respect to electronic-brush surface locations based on the ultrasonic signals.

13. The system of claim 12 further comprising:
means for emitting an ultrasonic signal from a first electronic-paint surface location;
means for receiving the ultrasonic signal at a second electronic-paint surface location; and
means for determining a distance between the first electronic-paint surface location and the second electronic-paint surface location based on the emitted ultrasonic signal and the received ultrasonic signal.

14. The system of claim 12 further comprising:
means for determining an electronic-brush rotation based on ultrasonic signals communicated between a plurality of spaced-apart electronic brush locations and the electronic-paint surface location means.

15. The system of claim 12 further comprising:
means for determining an electronic-brush rotation based on tilt signals sent from the electronic brush.

16. An electronic brush, comprising:
an electronic-brush housing (28); and
at least one ultrasonic transducer (32) attached to the electronic-brush housing (28), wherein ultrasonic signals communicated between the electronic-brush ultrasonic transducer (32) and at least two ultrasonic transducers positioned on a surface allow a determination of an electronic-brush location with respect to locations of the ultrasonic transducers positioned on the surface.

17. The electronic brush of claim 16 further comprising:
a second ultrasonic transducer (34) attached to the electronic brush (30) and spaced apart from the first electronic-brush ultrasonic transducer (32), wherein ultrasonic signals communicated between the electronic-brush ultrasonic transducers (32, 34) and at least one of the ultrasonic transducers positioned on the surface allow a determination of an electronic-brush rotation.

18. The electronic brush of claim 16 further comprising:
a tilt sensor (36) attached to the electronic brush (30), wherein a tilt signal from the tilt sensor (36) allows a determination of an electronic-brush rotation.

19. The electronic brush of claim 16 further comprising:
a controller (40) operably coupled to the electronic-brush ultrasonic transducer (32) to determine the electronic-brush location based on the ultrasonic signals.

20. The electronic brush of claim 19 wherein the controller is located in one of the electronic brush (30) or a digital computing device operably coupled to the electronic brush.
